(19) United States
(12) Patent Application Publication
(10) Pub. No.: US 2026/0034594 A1
(43) Pub. Date: Feb. 5, 2026

(54) Electric Power Tool

(71) Applicant: YAMABIKO CORPORATION, Tokyo (JP)

(72) Inventor: Kenji NAKANO, Ohme-shi (JP)

(21) Appl. No.: 19/272,040

(22) Filed: Jul. 17, 2025

(30) Foreign Application Priority Data
Jul. 31, 2024 (JP) 2024-124545

(51) Int. Cl. B23D 57/02

(52) U.S. Cl. CPC B23D 57/023

(57) ABSTRACT

An electric power tool includes a main body section with a battery compartment into which a battery is inserted from above and covered by a cover; an electric work section at a front of the main body section that operates using battery power; a front handle positioned above the main body section and ahead of the battery compartment, including a first part extending in a crossing direction intersecting front-rear and up-down directions; and a rear handle extending rearward from the main body section, wherein the battery stored in the battery compartment protrudes above a virtual plane that contacts upper regions of both the front handle's first part and the rear handle.

### CROSS REFERENCE TO RELATED APPLICATIONS

The present application claims priority under 35 U.S.C. § 119 to Japanese Patent Application No. 2024-124545, filed on Jul. 31, 2024. the contents of which are incorporated herein by reference in their entirety. The present invention relates to an electric power tool.

### BACKGROUND

### Technical Field

The present disclosure relates to an electric power tool.

### Related Art

CN117356287A discloses a chain saw (battery operated work tool). In this chainsaw, the entire battery is disposed below a virtual plane that contacts the handle tube and the operation area.

With such a configuration, even if the chainsaw falls with the upper side thereof facing vertically downward, the battery does not directly hit the ground, and the shock can be absorbed by the handle tube and operating area.

However, in such a configuration, it is difficult to mount a large-capacity battery (i.e., one with a large outer size), and to accommodate such a battery, the overall size of the chainsaw must be increased.

In view of the above circumstances, the present disclosure provides an electric power tool that mitigates shock to the battery upon being dropped, without increasing overall size.

### SUMMARY

According to an aspect of the present disclosure, an electric power tool includes: a main body section including a battery compartment into which a battery is inserted from above and stored, and a cover attached to the battery compartment so as to cover the battery stored in the battery compartment from above; an electric work section provided at a front side of the main body section and is configured to operate with power supplied from the battery; a front handle positioned above the main body section and ahead of the battery compartment, the front handle including a first part extending in a crossing direction intersecting a front-rear direction and an up-down direction; and a rear handle connected to a rear side of the main body section so as to extend rearward, wherein the battery stored in the battery compartment protrudes above the virtual plane when a virtual plane is defined that contacts an upper region of the first part of the front handle and an upper region of the rear handle.

According to such an aspect, the shock to the battery upon being dropped can be mitigated without increasing the size thereof.

### BRIEF DESCRIPTION OF DRAWINGS

FIG. 1 is a left side view showing the overall configuration of the chainsaw.

FIG. 2 shows the chainsaw from above.

FIG. 3 shows the chainsaw from below.

FIG. 4 shows the positional relationship of each part with respect to the battery.

FIG. 5 is an enlarged view showing a part of the cross-section taken along line A-A in FIG. 2.

FIGS. 6A and 6B show another configuration example of the cover.

FIGS. 7A and 7B show another configuration example of the cover.

### DETAILED DESCRIPTION

The following drawings are used to describe the embodiment of the electric power tool. The various features shown in the following embodiments can be combined with each other.

In the following, a chainsaw for cutting trees, boards, and the like will be represented as an example of an electric power tool.

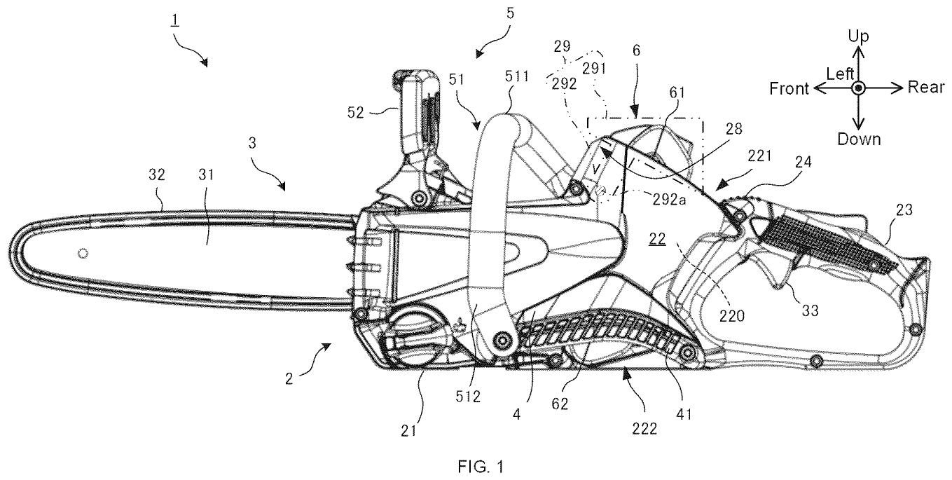

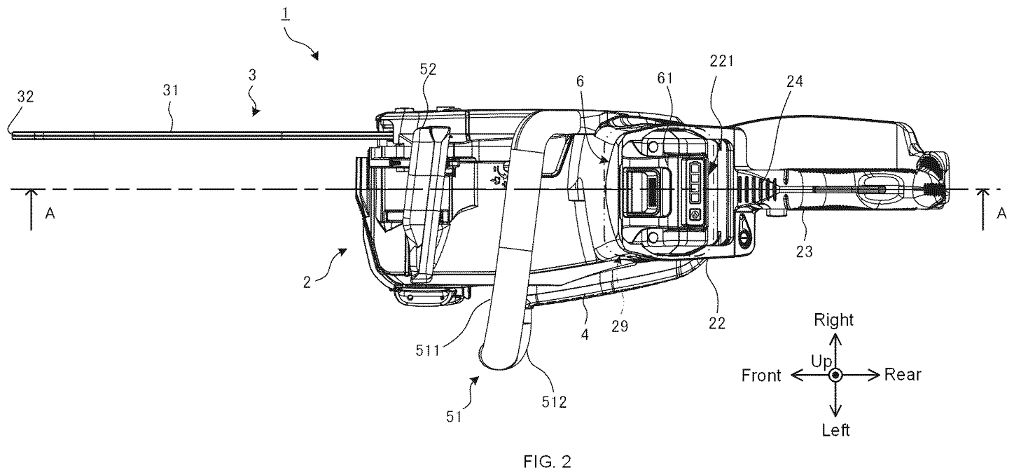

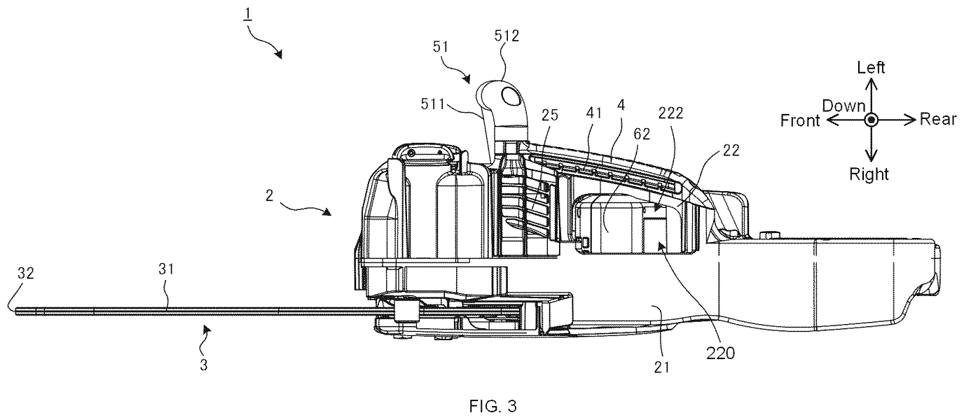

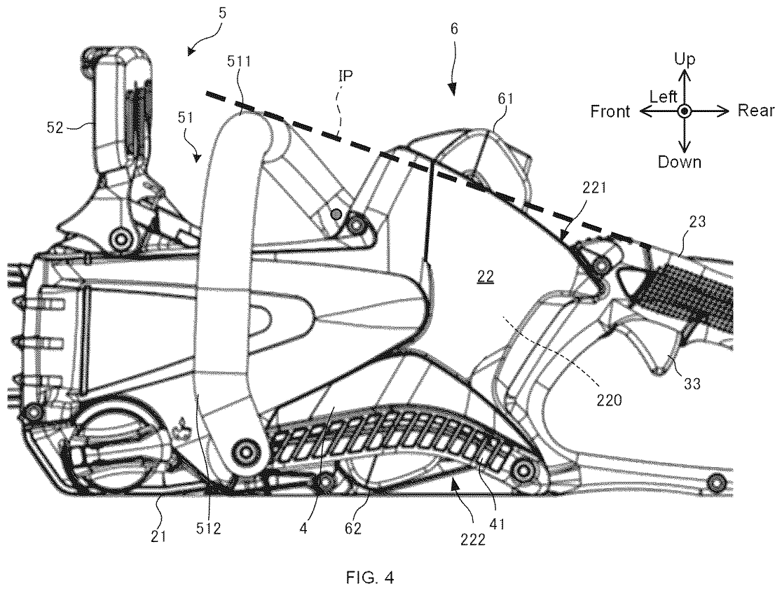

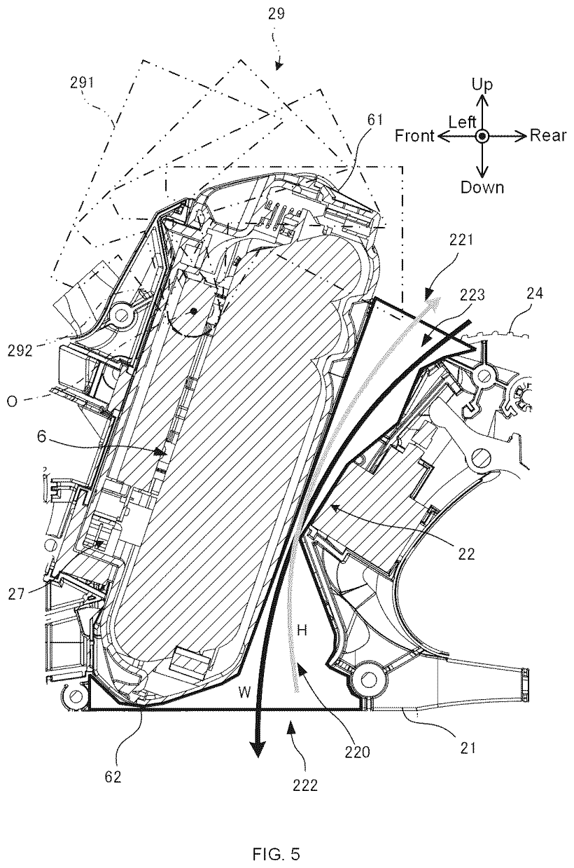

FIG. 1 is a left side view showing the overall configuration of the chainsaw. FIG. 2 shows the chainsaw from above. FIG. 3 shows the chainsaw from below. FIG. 4 shows the positional relationship of each part with respect to the battery. FIG. 5 is an enlarged view showing a part of the cross-section taken along line A-A in FIG. 2.

In the present specification, the vertical direction, front-rear direction, and left-right direction are defined as shown in the figure.

Specifically, in the chainsaw 1, the vertical direction is defined as the direction perpendicular to a flat and horizontal installation surface when the chainsaw is placed thereon. In addition, the front-rear direction is defined as the direction orthogonal to the vertical direction, and the left-right direction is defined as the direction orthogonal to both the vertical direction and the front-rear direction.

The chainsaw 1 includes a main body section 2, an electric work section 3, an air intake section 4, a handle portion 5 including a front handle 51, a rear handle 23, and a battery 6.

The electric work section 3 is provided at the front side of the main body section 2 and is configured to operate using electric power supplied from the battery 6 when the operator performs a task with the chainsaw 1. Through this operation, the electric work section 3 directly acts on the work object. Here, the work performed by the operator is, for example, cutting trees, boards, and the like.

The electric work section 3 includes a guide bar 31, saw chain 32, and lever 33. The guide bar 31 is a plate-like member that extends in the front-rear direction, and the rear end thereof is attached to the main body section 2. The annular saw chain 32 is wound around the outer peripheral portion of the guide bar 31.

Although not shown in FIG. 1, the main body section 2 contains the control board, drive gear, motor controller, and the like.

The saw chain 32 is engaged with the drive gear. The drive gear is rotationally driven by the motor.

The control board executes a control process that controls the rotation of the motor by the lever 33 is operated.

With the above configuration, when the operator operates the lever 33, the motor controlled by the control board rotates the drive gear, and the resulting rotational force causes the saw chain 32 to rotate along the outer periphery of the guide bar 31.

The main body section 2 is formed of a resin material or the like and serves as a housing (also referred to as a “case”) that contains the aforementioned motor and other components. This main body section 2 includes a bottom surface portion 21 and a battery compartment 22.

The bottom surface portion 21 is the portion that contacts the installation surface when the chainsaw 1 is placed on a flat installation surface. In the present embodiment, the bottom surface portion 21 includes a flat surface in contact with the installation surface, but the chainsaw 1 may remain stable when placed on the installation surface, and the shape may be one that contacts the installation surface at multiple sides or points.

The battery 6 is inserted into the battery compartment 22 from above for installation. The rear handle 23 is connected to the rear side of the main body section 2 so as to extend rearward. This rear handle 23 is a portion to be gripped by the operator when performing electrical work. The rear handle 23 is an elongated rod-shaped portion in the front-rear direction and is formed with dimensions suitable for being easily gripped by the operator's hand. It should be noted that the rear handle 23 can also be regarded as a part of the main body section 2.

The air intake section 4, which includes an air intake port 41, forms a passage through which air introduced from the air intake port 41 is guided into the interior of the main body section 2 as cooling air.

The handle portion 5 includes the front handle 51 and a front hand guard 52.

The front handle 51 is a portion to be gripped by the operator during electrical work. As shown in FIG. 2, the front handle 51 is positioned above the main body section 2 and forward of the battery compartment 22, which includes the first part 511 extending in a crossing direction (substantially the left-right direction) that intersects both the front-rear and vertical directions, and the second part 512 that continues from the first part 511 and is provided from the upper side to the left side of the main body section 2. With this configuration, the operator can switch between gripping the first part 511 and the second part 512 depending on whether the cutting work object is oriented vertically or horizontally.

The front hand guard 52 protects the operator's hand gripping the front handle 51 from injury and also functions as a brake for stopping the operation of the electric work section 3.

As described above, the operator of the chainsaw 1 carries the main body section 2 by holding the front handle 51 and rear handle 23 and rotates the saw chain 32 to work on a work object such as a tree.

In the chainsaw 1, the side of the saw chain 32 where work is performed is defined as the front side, and the side of the rear handle 23 that is grasped by the operator is defined as the rear side, and the directions pointing to the front side and the rear side are defined as the front-rear direction. In addition, when viewed from the rear side toward the front side, the leftward direction and rightward direction are defined as the left-right direction.

The battery 6 has an elongated external shape. This battery 6 is inserted from the upper side into the storage space 220 of the battery compartment 22, with the longitudinal direction thereof serving as the insertion direction.

Hereinafter, when the battery 6 is inserted into the battery compartment 22, the end located on the upper side is referred to as the upper end 61, and the end located on the lower side is referred to as the lower end 62.

On the other hand, the battery 6 is removed upward along the takeout direction that is opposite to the insertion direction.

The battery compartment 22 includes a storage space 220 into which the battery 6 can be inserted from above, which detachably holds the battery 6 inserted into the storage space 220. The storage space 220 includes the first opening 221 on the upper side through which the battery 6 passes during insertion, and the second opening 222 on the lower side opposite to the first opening 221.

The second opening 222 is provided with a size that allows a worker's finger to pass through.

According to this aspect, when an operator inserts a finger into the second opening 222 and pushes the lower end 62 of the battery 6, a force can be applied to the battery 6 in the removal direction (upward), making it easier to remove the battery 6 than in the case where the second opening 222 is not provided. In addition, since providing the second opening 222 is easier than providing, for example, an extraction mechanism with a spring portion and a lever, the battery can be easily removed from the chainsaw 1 with a simpler configuration.

The first opening 221 is where the storage space 220 opens to the outside on the upper end 61 side of the battery 6. The second opening 222 is where the storage space 220 opens to the outside at the lower end 62 side of the battery 6. That is, when the battery compartment 22 of the main body section 2 is placed with the bottom surface portion 21 facing downward, the second opening 222 is positioned lower than the first opening 221. According to this configuration, the battery 6 can be inserted into the storage space 220 by the own weight thereof. Therefore, compared to the case where the positional relationship between the first opening 221 and the second opening 222 is reversed, the battery 6 can be more easily inserted.

As shown in FIG. 2, the main body section 2 is provided with a non-slip 24 at the rear side of the first opening 221 (battery compartment 22). The non-slip 24 is formed by a plurality of ribs, each extending in the left-right direction. The non-slip 24 is a portion that contacts the operator's thumb when gripping the rear handle 23, and the operator's fingers when removing the battery 6, which is configured to reduce the likelihood of the operator's fingers slipping.

The non-slip 24 is not limited to a plurality of ribs, and may be, for example, a surface provided with a plurality of protrusions, a plurality of depressions, or a file-like texture such as a double-cut or wavy-cut pattern.

In addition, as shown in FIG. 3, the main body section 2 is provided with an exhaust port 25 on the front side of the second opening 222. The exhaust port 25 discharges to the outside the air (cooling air) that is taken in from the air intake port 41 and used to cool heat-generating components such as a motor and a control board arranged inside the main body section 2.

As described above, the battery compartment 22 includes the second opening 222 located on the lower end 62 side of the battery 6. In this configuration, the length (dimension) of the battery 6 in the left-right direction is greater than length (dimension) of the second opening 222 in the left-right direction. In other words, a portion of the lower end 62 of the battery 6 is covered by the bottom surface portion 21.

Thus, the second opening 222 has a shape and size such that the battery 6 inserted into the storage space 220 is prevented from passing through by the bottom surface portion 21 or the like. According to this aspect, the structural strength of the main body section 2 can be more easily ensured than in a case where the second opening 222 has a shape and size that allows the battery 6 to pass through, as in the case of the first opening 221.

In addition, the exhaust port 25 is located between the electric work section 3 and the second opening 222. According to this aspect, foreign matter such as sawdust generated during operation can be prevented from entering the storage space 220 by the air discharged from the exhaust port 25.

Further, by orienting the direction of the air discharged from the exhaust port 25 toward the side on which the electric work section 3 is provided in the left-right direction (the lower side in FIG. 3), it is possible to further prevent foreign matter such as sawdust from entering the storage space 220.

As shown in FIG. 5, the battery compartment 22 forms a gap 223 between the battery 6 and the battery 6 when the battery 6 is inserted (stored) in the storage space 220. The gap 223 is open to the upper side of the battery compartment 22 at the first opening 221 and also open downward in the battery compartment at the second opening 222. In other words, gap 223 penetrates the main body section 2 (battery compartment 22) top and bottom even when the battery 6 is stored in the storage space 220.

In addition, the upper main body section 2 includes a cover 29 that is mounted on the battery compartment 22 to cover the battery 6 stored in the battery compartment 22 from the top, as shown in FIG. 1 and FIG. 5. The cover 29 is configured, in a state of being mounted to the battery compartment 22, to expose the gap 223 to the outside, with covering the side of the upper end 61 of the battery 6 while not covering the upper side of the gap 223.

According to this configuration, water W, such as rainwater, is discharged to the outside from the lower side of the battery compartment 22 through the gap 223. Therefore, adverse effects (e.g., electric leakage or corrosion) on the battery 6 and other electrical components can be suitably prevented. In addition, the heat H generated by the battery 6 is not accumulated inside the battery compartment 22 but is discharged to the outside from the upper side, thereby sufficiently preventing malfunction of the battery 6.

Further, the cover 29 is rotatably attached to the battery compartment 22. According to this configuration, the battery 6 can be attached to and removed from the battery compartment 22 with relative ease.

As shown in FIG. 4, when a virtual plane is defined that contacts an upper region of the first part 511 of the front handle 51 and an upper region of the rear handle 23, the battery 6 stored in the battery compartment 22 protrudes above the virtual plane.

According to this configuration, the battery 6 is disposed such that the longitudinal direction thereof (insertion direction) is oriented vertically rather than in the front-rear direction of the main body section 2 and so as to protrude above the virtual plane IP. Therefore, even a relatively large-capacity (physically large-sized) battery 6 can be installed (mounted) without increasing the size of the chainsaw 1 in the front-rear direction.

In such a chainsaw 1, as shown in FIGS. 1 and 2, the cover 29 is mounted on the battery compartment 22 so as to cover the battery 6 from above. Accordingly, even if the chainsaw 1 is accidentally dropped with the upper side thereof facing vertically downward, the front handle 51 and the cover 29 will make contact with the ground first. As a result, the front handle 51 and the cover 29 absorb the impact from the fall, thereby mitigating the damage applied to the battery 6.

From this perspective, it is preferable that a buffer absorption space where the battery 6 and the cover 29 are not in contact be formed between the battery 6 and the cover 29 that covers the battery 6 stored in the battery compartment 22 from the upper side. Thus, by providing a buffer absorption space 290 between the cover 29 and the battery 6, the cover 29 absorbs the shock, thereby further mitigating the shock applied to the battery 6. In this case, the cover 29 is preferably made of, for example, a hard resin material or a metallic material.

Further, a shock absorbing material is preferably disposed between the cover 29 that covers the battery 6 stored in the battery compartment 22 from above, and at least one of the battery 6 and the battery compartment 22. By disposing the shock absorbing material between the cover 29 and the battery compartment 22, the impact applied to the battery 6 can be further alleviated. Examples of the shock absorbing material include blocks made of rubber or viscoelastic foam (shock-absorbing material), as well as various hollow bodies, and various foams (sponges).

Specific placement positions of the shock absorbing material include, for example, a position between the upper end 61 of the battery 6 and the cover body 291, and a position between the edge of the cover body 291 and the edge of the battery compartment 22. In addition, the shock absorbing material may be fixed to the cover 29 (cover body 291), to the battery compartment 22, or to none of them.

The cover 29 includes a cover body 291 covering the battery 6 and a leg 292 connected to the cover body 291 and fixed to the battery compartment 22. In the present embodiment, as shown in FIG. 1, the lower end of the leg 292 is pivotably attached to the main body section 2 (battery compartment 22) at rotary shaft portion 292a.

As a result, the cover 29 is configured to rotate between the first position in which the battery 6 is covered, and the second position in which the cover is rotated forward to expose the battery 6 to the outside. According to this configuration, the cover body 291 of the cover 29 in the first position can cover the battery 6 and the electric components located below the battery 6, thereby more effectively preventing adverse effects on the electric components caused by water W.

In the present embodiment, the battery compartment 22 includes a connection terminal 27 located ahead of the gap 223, the connection terminal being electrically connected to the battery 6. According to this configuration, it is particularly easy to protect the connection terminal 27, which is susceptible to adverse effects caused by water W.

In addition, as shown in FIG. 1, the cover body 291 of the cover 29 in the first position covers the area near the top 28 of the main body section 2 (the front boundary between the battery compartment 22 and the battery 6), which further effectively prevents water W from contacting the connection terminal 27.

Further, as shown in FIG. 5, the center of rotation O of the cover 29 is positioned, in the front-rear direction, between the connection terminal 27 and the gap 223. According to this configuration, it is easy to prevent water W from entering the front boundary between the battery compartment 22 and the battery 6, even when the cover 29 is rotated from the first position to the second position.

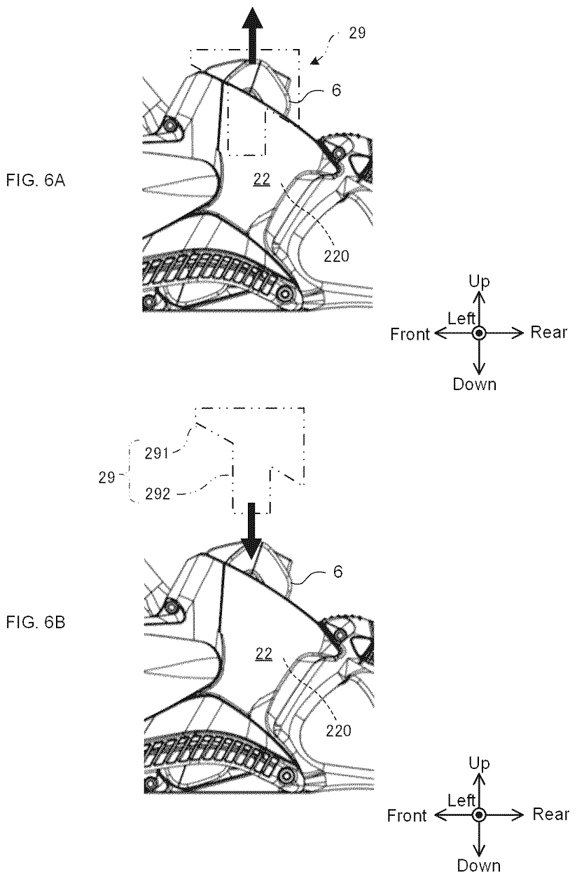

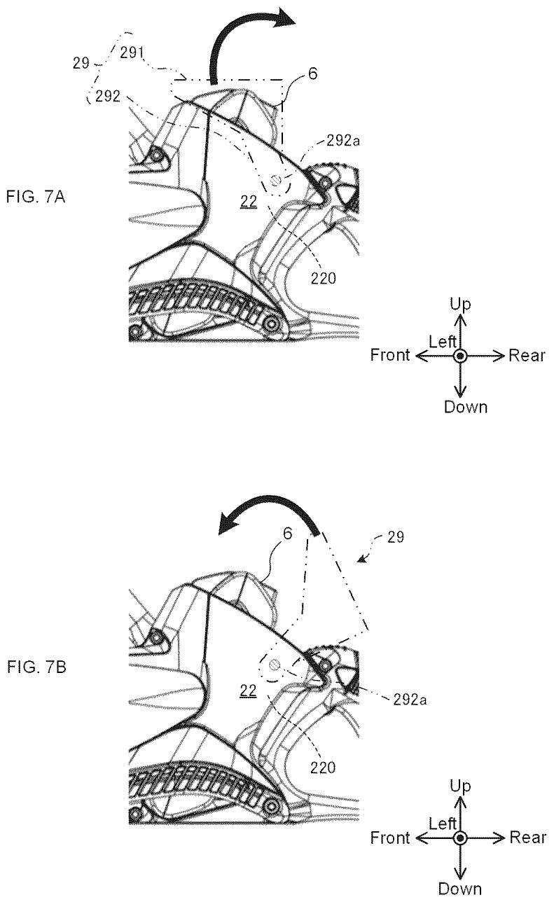

The cover 29 may also adopt the configurations shown in FIGS. 6 and 7.

FIGS. 6A, 6B, 7A and 7B show other configuration examples of the cover, respectively.

The cover 29 shown in FIGS. 6A and 6B is configured to be mounted in the battery compartment 22 by sliding the cover 29 in the vertical direction.

The cover 29 shown in FIGS. 7A and 7B includes a rotary shaft 292a at a position corresponding to the gap 223 in the battery compartment 22. The cover 29 is configured to rotate between the first position, which covers the battery 6, and the second position, which rotates rearward to expose the battery 6 to the outside.

The present disclosure is not limited thereto, although the second embodiment as described above describes a chainsaw as an example of an electric power tool. Electric power tool may be, for example, hedge trimmers, cutters, blowers, and the like. In other words, as long as a battery is mounted in the battery compartment of the main body section and the tool includes an electric work section that operates with electric power supplied from this battery, any electric power tool may be employed.

In addition, it may be provided in each of the forms according to
(1) An electric power tool, including: a main body section including a battery compartment into which a battery is inserted from above and stored, and a cover attached to the battery compartment so as to cover the battery stored in the battery compartment from above; an electric work section provided at a front side of the main body section and is configured to operate with power supplied from the battery; a front handle positioned above the main body section and ahead of the battery compartment, the front handle including the first part extending in a crossing direction intersecting a front-rear direction and an up-down direction; and a rear handle connected to a rear side of the main body section so as to extend rearward, wherein when a virtual plane is defined that contacts an upper region of the first part of the front handle and an upper region of the rear handle, the battery stored in the battery compartment protrudes above the virtual plane.
(2) The electric power tool according to (1), wherein a buffer absorption space is formed between the battery and the cover that covers the battery stored in the battery compartment from above.
(3) The electric power tool according to (1) or (2), wherein a shock absorbing material is disposed between the cover that covers the battery stored in the battery compartment from above, and at least one of the battery and the battery compartment.
(4) The electric power tool according to any one of (1) to (3), wherein: the battery compartment forms a gap open upward between the battery and the compartment in a state where the battery is inserted; and the cover is configured, in a state of being attached to the battery compartment, to expose the gap to the outside.
(5) The electric power tool according to (4), wherein the cover is rotatably attached to the battery compartment.
(6) The electric power tool according to (5), wherein the cover is configured to rotate between the first position in which the battery is covered, and the second position in which the cover moves forward to expose the battery to outside.
(7) The electric power tool according to any one of (4) to (6), wherein the gap is also open downward in the battery compartment.
(8) The electric power tool according to any one of (4) to (7), wherein the battery compartment includes a connection terminal located ahead of the gap, the connection terminal being electrically connected to the battery.
(9) The electric power tool according to (8), wherein the cover is rotatably attached to the battery compartment, and a center of rotation thereof is positioned, in a front-rear direction, between the connection terminal and the gap.
(10) The electric power tool according to any one of (4) to (9), wherein the cover includes: a cover body covering the battery; and legs connected to the cover body and fixed to the battery compartment.

Of course, this is not the case.

Finally, although various embodiments related to the present invention have been described, these are presented merely as examples and are not intended to limit the scope of the invention. The novel embodiment can be implemented in various other forms, and various omissions, substitutions, and changes can be made without departing from the scope of the disclosure. Embodiments and variations thereof are included in the scope and gist of the invention and the equivalents thereof according to the claims.

What is claimed is:

1. An electric power tool, comprising:
a main body section including a battery compartment into which a battery is inserted from above and stored, and a cover attached to the battery compartment so as to cover the battery stored in the battery compartment from above;
an electric work section provided at a front side of the main body section and is configured to operate with power supplied from the battery;
a front handle positioned above the main body section and ahead of the battery compartment, the front handle including a first part extending in a crossing direction intersecting a front-rear direction and an up-down direction; and
a rear handle connected to a rear side of the main body section so as to extend rearward, wherein
when a virtual plane is defined that contacts an upper region of the first part of the front handle and an upper region of the rear handle, the battery stored in the battery compartment protrudes above the virtual plane.

2. The electric power tool according to claim 1, wherein
a buffer absorption space is formed between the battery and the cover that covers the battery stored in the battery compartment from above.

3. The electric power tool according to claim 1, wherein
a shock absorbing material is disposed between the cover that covers the battery stored in the battery compartment from above, and at least one of the battery and the battery compartment.

4. The electric power tool according to claim 1, wherein:
the battery compartment forms a gap open upward between the battery and the compartment in a state where the battery is inserted; and
the cover is configured, in a state of being attached to the battery compartment, to expose the gap to the outside.

5. The electric power tool according to claim 4, wherein
the cover is rotatably attached to the battery compartment.

6. The electric power tool according to claim 5, wherein
the cover is configured to rotate between a first position in which the battery is covered, and a second position in which the cover moves forward to expose the battery to outside.

7. The electric power tool according to claim 4, wherein
the gap is also open downward in the battery compartment.

8. The electric power tool according to claim 4, wherein
the battery compartment includes a connection terminal located ahead of the gap, the connection terminal being electrically connected to the battery.

9. The electric power tool according to claim 8, wherein
the cover is rotatably attached to the battery compartment, and a center of rotation thereof is positioned, in a front-rear direction, between the connection terminal and the gap.

10. The electric power tool according to claim 4, wherein
the cover includes:
a cover body covering the battery; and
legs connected to the cover body and fixed to the battery compartment.
